(19) United States
(12) Patent Application Publication
(10) Pub. No.: US 2018/0237955 A1
(43) Pub. Date: Aug. 23, 2018

(54) Copolyester Material with Low Melting Point, Spinning and Weaving Functions and Method for Forming the Copolyester Material

(71) Applicant: Nan Pao Resins Chemical Co., Ltd., Tainan City (TW)

(72) Inventors: Juh-Shyong Lee, Tainan-City (TW); Yuung-Ching Sheen, Tainan City (TW); Shu-Yu Ho, Tainan City (TW)

(21) Appl. No.: 15/438,817

(22) Filed: Feb. 22, 2017

(51) Int. Cl. D01F 6/84; C08G 63/16; C08G 63/78; D06C 13/00; D01D 10/02; D03D 15/00

(52) U.S. Cl. CPC D01F 6/84; C08G 63/16; C08G 63/78; D06C 13/00; D10B 2501/06; D03D 15/00; D10B 2501/043; D10B 2503/00; D01D 10/02

(57) ABSTRACT

A method for forming a copolyester material includes preparing a solution of monomers, applying a polymerization to form a copolyester having a low melting point, spinning the copolyester into fiber threads to form a copolyester fiber, weaving or knitting the copolyester fiber with a common fiber to form a composite fiber having a sheet shape, cutting the composite fiber to form a determined shape, applying a hot-press process on the composite fiber under a temperature of about 120° C. to 200° C., to release tackiness of the copolyester, so that the copolyester fiber and the common fiber are bonded tightly and closely, and forming a tough film on a surface of the composite fiber by the copolyester, so that the composite fiber has functions of stiffness and abrasion resistance by the tough film.

### BACKGROUND OF THE INVENTION

### 1. Field of the Invention

The present invention relates to a copolyester material and, more particularly, to a copolyester material with a low melting point, and a method for forming the copolyester material.

### 2. Description of the Related Art

Usually, the common product in the market include shoes, bags clothes and the like. A shoe upper is made of leather, suede leather or plastic material or fabric. At present, the sport shoe upper uses hot-melt fibers which are made of thermoplastic elastomer (TPU material) which presents an elastomeric feature at the normal temperature and becomes a plastic feature when being heated. Thus, the sport shoe upper is combined with a common fiber, such as PET, by stickiness of the thermoplastic elastomer. However, the TPU material contains aromatic structure which produces poisonous smokes when being burned so that the thermoplastic elastomer easily pollutes the environment and TPU is different with PET in molecular composition so that cannot be recycled and reused, thereby causing a burden to the environment. In addition, the TPU material heat resistant poor and has a higher price and is easily deformed and the high technique for spinning, thereby increasing the price. Further, the TPU material easily hydrolysis or ages during a period of time, thereby decreasing the lifetime of the sport shoe upper.

### BRIEF SUMMARY OF THE INVENTION

The primary objective of the present invention is to provide a copolyester material of a low melting point with stiffness and abrasion resistance.

In accordance with the present invention, there is provided a method for forming a copolyester material, comprising:

preparing a solution of monomers;

applying a polymerization on the solution of monomers to form a polyester material or copolyester having a low melting point;

spinning the copolyester into fiber threads to form a copolyester fiber;

weaving or knitting the copolyester fiber of the copolyester with a common fiber into cloth, to form a composite fiber having a sheet shape;

cutting the composite fiber to form a determined shape;

applying a hot-press process on the composite fiber under a temperature of about 120° C. to 200° C., to melt the copolyester, so that the copolyester fiber and the common fiber are bonded tightly and closely; and

forming a tough film on a surface of the composite fiber by a feature of the copolyester, so that the composite fiber has functions of stiffness and abrasion resistance by the tough film.

Preferably, the copolyester has a melting point of about 100° C. to 180° C.

Preferably, the solution of monomers includes diacid, diol, a catalyst and an additive agent which are well mixed.

Preferably, the composite fiber is made into a shoe upper, a bag or a clothing.

Preferably, the common fiber includes PET, Nylon or nature materials.

According to the primary advantage of the present invention, the copolyester has a low melting point and excellent tacky and adhesion under the temperature of about 120° C. to 200° C. during a hot-press process, so that the copolyester fiber of the copolyester and the common fiber are bonded tightly and closely.

According to another advantage of the present invention, the composite fiber is formed with a tough film by the feature of the copolyester to have the function of stiffness and abrasion resistance by the tough film, so that the product made by the composite fiber is not worn out easily, thereby enhancing the lifetime of the product.

According to a further advantage of the present invention, the copolyester fiber of the copolyester has a lower price, thereby decreasing the cost of fabrication.

According to a further advantage of the present invention, the product made by the composite fiber can be recycled and will not pollute the environment.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart view of a method for forming a copolyester material in accordance with the preferred embodiment of the present invention.

FIG. 2 is a flow chart view of the copolyester material for a shoe upper in accordance with the preferred embodiment of the present invention.

FIG. 3 is a perspective view of a composite fiber in accordance with the preferred embodiment of the present invention.

FIG. 4 is a perspective view of the composite fiber for a shoe upper in accordance with the preferred embodiment of the present invention.

FIG. 5 is a perspective view of the composite fiber for a shoe product in accordance with the preferred embodiment of the present invention.

FIG. 6 is a perspective view of the composite fiber for a bag product in accordance with the preferred embodiment of the present invention.

FIG. 7 is a perspective view of the composite fiber for a clothing product in accordance with the preferred embodiment of the present invention.

### DETAILED DESCRIPTION OF THE INVENTION

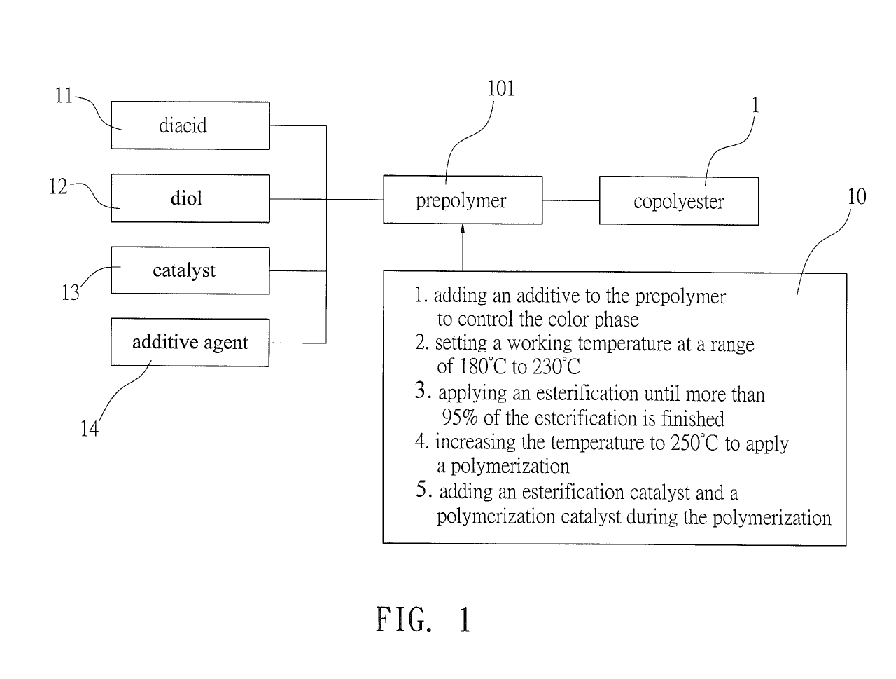

Referring to the drawings and initially to FIG. 1, a method for forming a copolyester material in accordance with the preferred embodiment of the present invention comprises preparing a solution of monomers 101 in a reaction tank, and applying a polymerization “a” on the solution of monomers 101 to form a copolyester 1 having a low melting point. The copolyester 1 is a polyester material.

The solution of monomers 101 includes diacid 11, diol 12, a catalyst 13 and an additive agent 14 which are well mixed.

In the preferred embodiment of the present invention, the diacid 11 in the solution of monomers 101 includes the aromatic and the aliphatic, such as Terephthalic acid (or dimethyl ester), Adipic acid, Isophthalic acid (or dimethyl ester) or the like, and the diol 12 in the solution of monomers 101 primarily includes the C2 to C6 aliphatic, such as 1,4-butanediol, ethylene glycol, 1,6-hexanediol or the like.

The polymerization “a” includes procedures of applying an additive and controlling the temperature, and preferably includes the following steps:

1. adding an additive to the solution of monomers 101 to control the color phase;

2. setting a ester reaction temperature at a range of 180° C. to 230° C.;

3. applying an esterification to the solution of monomers 101 until more than 95% of the esterification is finished;

4. increasing the temperature to 250° C. to apply a polymerization process to the solution of monomers 101; and

5. adding a esterification catalyst and a polymerization catalyst to the solution of monomers 101 in the beginning.

In the preferred embodiment of the present invention, the additive is an anti-oxidant. In the esterification, the diacid 11 and the diol 12 are reacted to perform the esterification reaction. When the percent conversion of the diacid 11 and the diol 12 is more than 95%, the esterification is finished. Thus, more than 95% of the solution of monomers 101 is esterified.

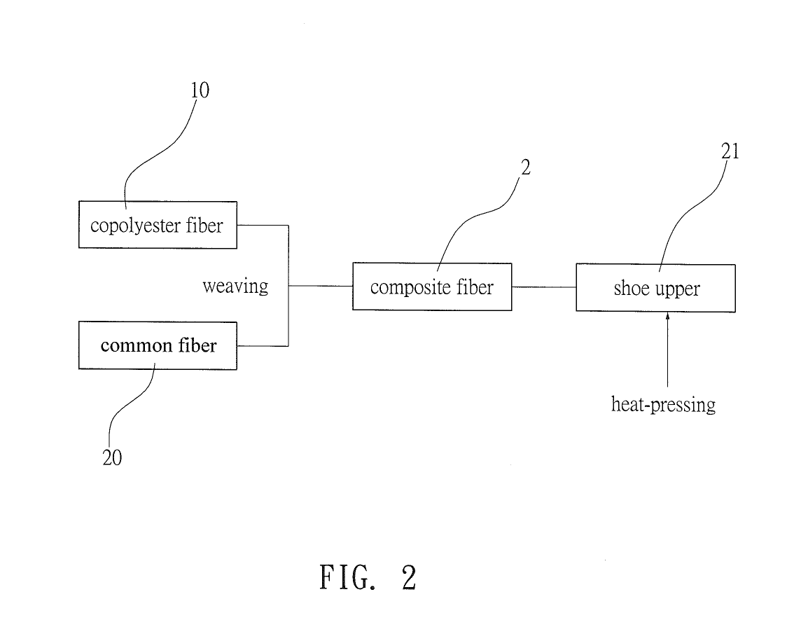

In the polymerization process, the degree of vacuum in the reaction tank is gradually adjusted in a stepwise manner to a value under 10 torr. The polymerization process is stopped when a required viscosity is reached, thereby forming the copolyester 1 after the polymerization process. The required viscosity is an intrinsic viscosity of the copolyester 1 to judge if the polymerization reaches the requirement. The copolyester 1 is an innovative environmentally friendly material and has a melting point of about 100° C. to 180° C. The copolyester 1 is spun into fiber threads to form a copolyester fiber 10 (see FIG. 2). The copolyester fiber 10 of the copolyester 1 and a common fiber 20 (see FIG. 2) are woven or knitted into cloth, so that the copolyester fiber 10 and the common fiber 20 are combined to form an environmentally friendly plastic.

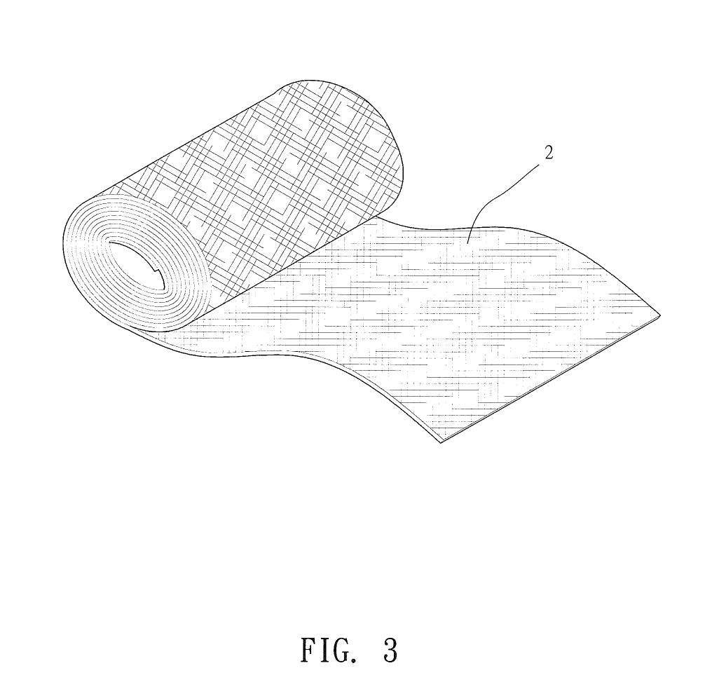

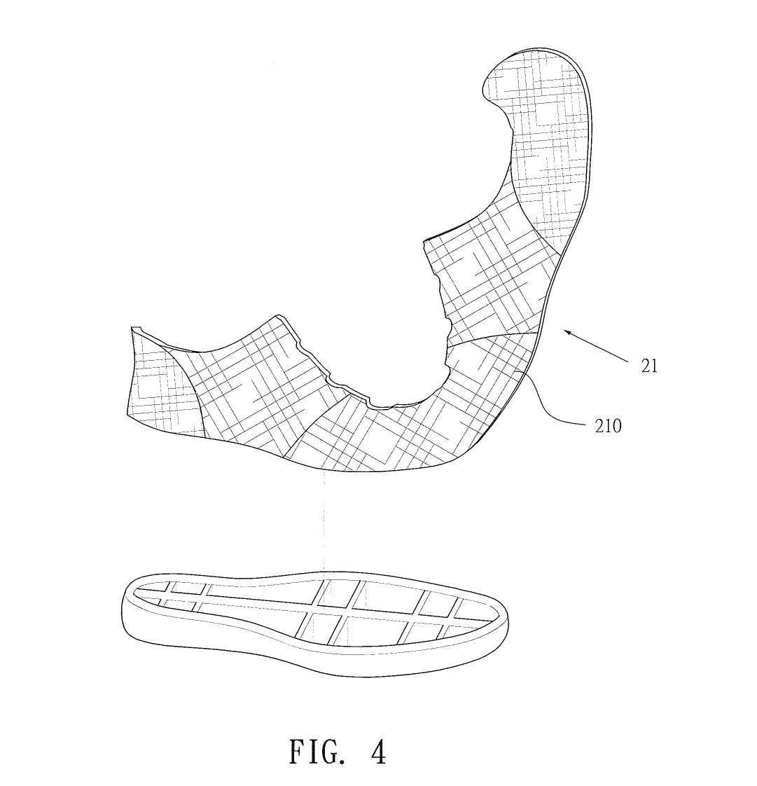

Referring to FIGS. 2-4 with reference to FIG. 1, the copolyester fiber 10 and the common fiber 20 are woven and combined to form a composite fiber 2 having a sheet shape. The common fiber 20 includes PET, Nylon or nature materials. The composite fiber 2 is cut to form a determined shape, such as a shoe upper 21. Then, a hot-press process is applied on the shoe upper 21 (or the composite fiber 2) under the temperature of about 120° C. to 200° C., to release the tackiness of the copolyester 1, so that the copolyester fiber 10 and the common fiber 20 are bonded tightly and closely. In such a manner, the shoe upper 21 (or the composite fiber 2) has a surface formed with a tough film 210 by the feature of the copolyester 1, so that the shoe upper 21 (or the composite fiber 2) has the function of stiffness and abrasion resistance by the tough film 210, thereby enhancing the lifetime of the shoe upper 21. Thus, the composite fiber 2 functions as a semi-product which is cut properly according to the practical requirement, so as to form a composite cloth product which is a combination of cloth material and plastic material.

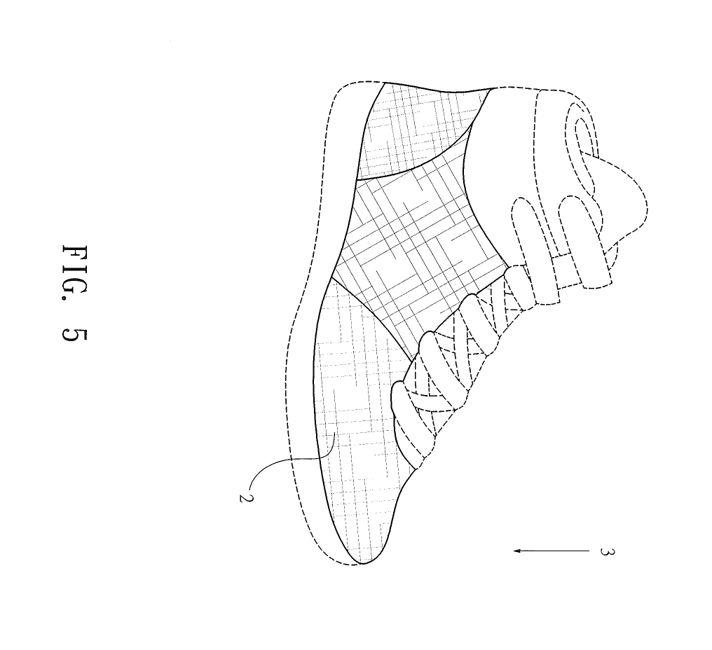

Referring to FIG. 5, the composite fiber 2 is available for a shoe product 3.

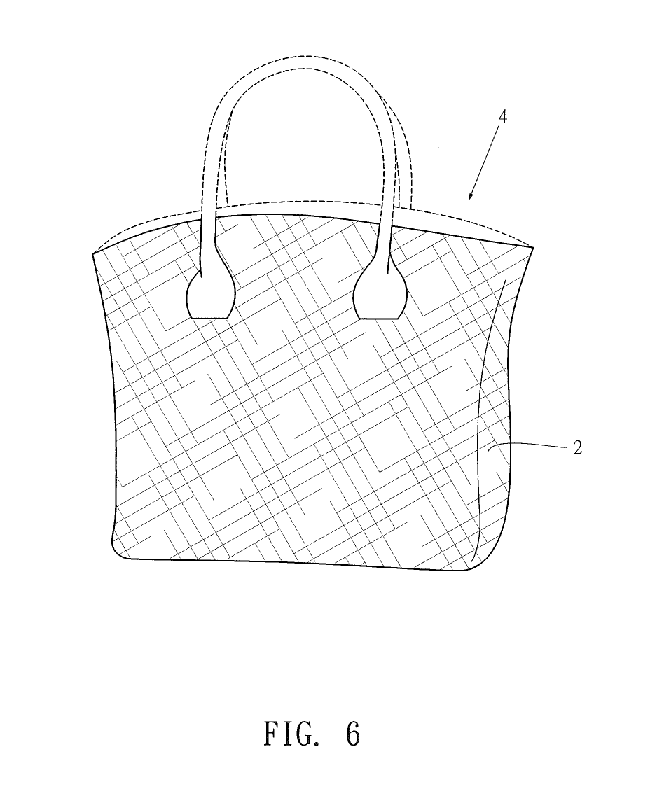

Referring to FIG. 6, the composite fiber 2 is available for a bag product 4.

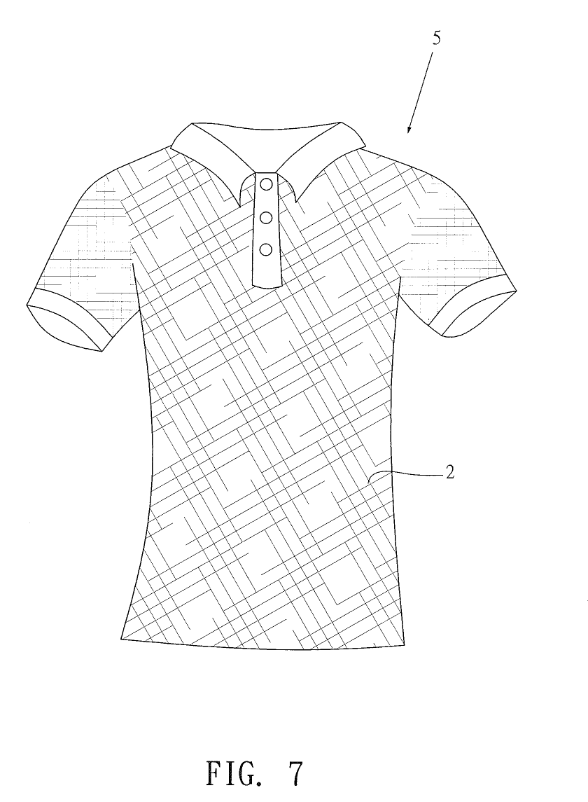

Referring to FIG. 7, the composite fiber 2 is available for a clothing product 5.

Accordingly, the copolyester 1 has a low melting point and releases tackiness under the temperature of about 120° C. to 200° C. during a hot-press process, so that the copolyester fiber 10 of the copolyester 1 and the common fiber 20 are bonded tightly and closely. In addition, the composite fiber 2 is formed with a tough film 210 by the feature of the copolyester 1 to have the function of stiffness and abrasion resistance by the tough film 210, so that the product made by the composite fiber 2 is not worn out easily, thereby enhancing the lifetime of the product. Further, the copolyester fiber 10 of the copolyester 1 has a lower price, thereby decreasing the cost of fabrication. Further, the product made by the composite fiber 2 can be recycled and will not pollute the environment.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for forming a copolyester material, comprising:
preparing a solution of monomers;
applying a polymerization on the solution of monomers to form a polyester material or copolyester having a low melting point;
spinning the copolyester into fiber threads to form a copolyester fiber;
weaving or knitting the copolyester fiber of the copolyester with a common fiber into cloth, to form a composite fiber having a sheet shape;
cutting the composite fiber to form a determined shape;
applying a hot-press process on the composite fiber under a temperature of about 120° C. to 200° C., to release tackiness of the copolyester, so that the copolyester fiber and the common fiber are bonded tightly and closely; and
forming a tough film on a surface of the composite fiber by a feature of the copolyester, so that the composite fiber has functions of stiffness and abrasion resistance by the tough film.

2. The method of claim 1, wherein the copolyester has a melting point of about 100° C. to 180° C.

3. The method of claim 1, wherein the solution of monomers includes diacid, diol, a catalyst and an additive agent which are mixed.

4. The method of claim 1, wherein the composite fiber is made into a shoe upper, a bag or a clothing.

5. The method of claim 1, wherein the common fiber includes PET, Nylon or nature materials.
